(19) United States
(12) Patent Application Publication
(10) Pub. No.: US 2024/0161026 A1
(43) Pub. Date: May 16, 2024

(54) SYSTEM AND METHOD FOR INTER-AGENCY RECOMMENDED COURSE OF ACTION

(71) Applicant: MOTOROLA SOLUTIONS, INC., CHICAGO, IL (US)

(72) Inventors: JESUS F. CORRETJER, WESTON, FL (US); FRANTZ PAUL, NORTH MIAMI BEACH, FL (US); PRATEEK PRADEEP, NEW WESTMINISTER (CA); HEMAPRIYA MANIVEL, BATAVIA, IL (US)

(21) Appl. No.: 18/055,471

(22) Filed: Nov. 15, 2022

(51) Int. Cl. G06Q 10/06; G06N 20/00; G08B 21/02

(52) U.S. Cl. CPC G06Q 10/063112; G06N 20/00; G08B 21/02

(57) ABSTRACT

Techniques for inter-agency recommended course of action are provided. An indication of an incident requiring a response from a first and a second public safety agency is received. An expected incident response based on standard operating procedures of the first and the second public safety agency is retrieved from a machine learning engine. A deviation from the expected incident response attributable to the second public safety agency is identified. A recommended course of action for the first public safety agency is retrieved from the machine learning engine. The recommended course of action based at least in part on historical incident responses. The recommended course of action is sent to the first public safety agency. Feedback related to the incident that includes when the recommended course of action was accepted and an incident outcome is received. The machine learning engine is updated based on the feedback.

### BACKGROUND

Public safety agencies (e.g. police, fire department, emergency medical services, special weapons and tactics teams, etc.) typically operate under the guidance of an established set of standard operating procedures. For example, a police officer conducting a traffic stop may have standard operating procedures indicating that the officer should activate his lights and siren, stop behind the detained vehicle, approach from the passenger side, etc. There may be similar standard operating procedures for other public safety agencies.

In some cases, a public safety incident (e.g. burning building, vehicle accident with injuries, etc.) may require a response from multiple agencies. Each of those agencies may have their own standard operating procedures. In order to ensure smooth operation at an actual public safety incident response, the various agencies may participate in cross-agency training in order to better collaborate. For example, training may allow the individual agencies to divide responsibilities. For example, in the case of a vehicle accident, the training may assign the task of traffic control to the police, site protection and victim extraction to the fire department, and victim aid to emergency medical services (EMS).

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments

FIG. 1 is an example of a system that may implement the inter-agency recommended course of action techniques described herein.

FIG. 2 is an example of a device which may be used to send recommendations to an agency responder and receive a response indicating if the recommendation was accepted.

FIG. 3 is an example of a flow diagram of providing inter-agency recommended courses of action for a specific incident according to the techniques described herein.

FIG. 4 is a general example of a flow diagram of providing inter-agency recommended courses of action for a specific incident according to the techniques described herein.

FIG. 5 is an example of a flow diagram of providing inter-agency recommended courses of action when an agency deviates from the standard operating procedures.

FIG. 6 is another example of a flow diagram of providing inter-agency recommended courses of action when an agency deviates from the standard operating procedures.

FIG. 7 is an example of a device that may implement the providing inter-agency recommended courses of action techniques described herein.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Although inter-agency training can help with multi-agency incident responses, such training may not be sufficient. A problem arises in that it is likely not possible to train for every possible incident type. The training may be cumbersome and difficult to remember in stressful situations, such as responding to a public safety incident. Furthermore, each individual agency may alter their own standard operating procedures independent of the other agencies, such that each agency may not be aware of the other agencies standard operating procedures.

The problem with multi-agency responses described above can be further exacerbated when an agency deviates from the expected agency procedure. For example, if a police officer's standard operating procedure (SOP) at a vehicle accident is to direct traffic, and that officer fails to execute that task, the entire incident response may be thrown into disarray, as a necessary task is not being completed.

The techniques described herein solve these problems individually and collectively. A system is provided that is equipped with the standard operating procedures of all agencies that would be involved in a multi-agency response, which may also be referred to as an inter-agency response. The system would also be configured to include the actions that each agency is expected to take when responding to an incident that requires and inter-agency response.

The system may push real-time contextually relevant and actionable recommendations to the public safety responders during an incident to help guide them collaborate during the inter-agency response. For example, the system may provide recommendations in accordance with the multi-agency training to reinforce those steps. In some cases, the recommendations could be used in incident responses that have not previously been trained. The actionable recommendations may be sent to the first responder's mobile devices. For example, the recommendations could be sent using a visual mechanism (e.g. text message, etc.) or an audible mechanism (e.g. text to speech conversion, etc.).

For every action taken by an agency, recommended actions for the other agencies may be provided. As such, the recommendations are not static and do not necessarily follow a fixed pattern, but rather are dependent on the specific context of the action each agency is currently engaged in. In some cases, the actions being taken by an agency are determined using automated mechanisms (e.g. cameras, sensors in the mobile device, natural language processing of radio traffic, etc.) such that the system need not rely on a first responder providing an indication of what action they are currently taking.

In addition to providing recommendations to first responders based on the defined standard operating procedures and defined inter-agency responses, the system may also monitor for deviations by any agency from the standard operating procedures. For example, a responder may not perform a response in accordance with what was expected. In such cases, the system may note this deviation and provide recommendations to the other responders to compensate for the deviation. For example, the recommendation could be based on what was done in previous responses where the same or similar deviation occurred. The recommendation could be based on the outcome of one or more previous responses (e.g. successful/not successful).

In all cases, the recommendations may be provided by the system to the first responder as a suggestion. It is up to the first responder to decide if the recommended action is taken. In some cases, the first responder may respond to the system indicating if the recommended action was taken. The system may then use the overall outcome of the incident to determine if taking the recommended action resulted in a successful or unsuccessful outcome. The overall outcome could be used by the system when determining recommendations in future actions where a responder deviated from the standard operating procedures.

A method is provided. The method comprises receiving an indication of an incident, the incident requiring a response from a first public safety agency and a second public safety agency. The method further comprises retrieving, from a machine learning engine, an expected incident response from each of the first public safety agency and the second public safety agency, the expected response based on standard operating procedures of the first public safety agency and the second public safety agency. The method further comprises identifying a deviation from the expected incident response attributable to the second public safety agency. The method further comprises retrieving, from the machine learning engine, a recommended course of action for the first public safety agency, the recommended course of action based at least in part on historical incident responses. The method further comprises sending the recommended course of action to the first public safety agency. The method further comprises receiving feedback related to the incident, the feedback including when the recommended course of action was accepted and an incident outcome. The method further comprises updating the machine learning engine based on the feedback.

In one aspect of the method, the feedback includes an actual course of action when the recommended course of action was rejected. In one aspect of the method, the method further comprises identifying a skill set of a member of the second public safety agency associated with the deviation from the expected incident response, identifying a skill set of a member of the first public safety agency that will receive the recommended course of action, wherein the recommended course of action is retrieved based on the skill set of the member of the second public safety agency and the skill set of the member of the first public safety agency.

In one aspect of the method, the deviation comprises the second agency not being at an incident scene. In one aspect of the method, the deviation comprises the second agency violating standard operating procedures. In one aspect of the method, the deviation comprises violation of an expected incident timeline.

A system is provided. The system includes a processor and a memory coupled to the processor. The memory contains a set of instructions thereon that when executed by the processor cause the processor to receive an indication of an incident, the incident requiring a response from a first public safety agency and a second public safety agency. The memory further includes instructions to receive an indication of an incident, the incident requiring a response from a first public safety agency and a second public safety agency. The memory further includes instructions to retrieve, from a machine learning engine, an expected incident response from each of the first public safety agency and the second public safety agency, the expected response based on standard operating procedures of the first public safety agency and the second public safety agency. The memory further includes instructions to identify a deviation from the expected incident response attributable to the second public safety agency. The memory further includes instructions to retrieve, from the machine learning engine, a recommended course of action for the first public safety agency, the recommended course of action based at least in part on historical incident responses. The memory further includes instructions to send the recommended course of action to the first public safety agency. The memory further includes instructions to receive feedback related to the incident, the feedback including when the recommended course of action was accepted and an incident outcome. The memory further includes instructions to update the machine learning engine based on the feedback.

In one aspect of the system, the feedback includes an actual course of action when the recommended course of action was rejected. In one aspect of the system, the memory further includes instructions to identify a skill set of a member of the second public safety agency associated with the deviation from the expected incident response, identify a skill set of a member of the first public safety agency that will receive the recommended course of action, wherein the recommended course of action is retrieved based on the skill set of the member of the second public safety agency and the skill set of the member of the first public safety agency.

In one aspect of the system, the deviation comprises the second agency not being at an incident scene. In one aspect of the system, the deviation comprises the second agency violating standard operating procedures. In one aspect of the system, the deviation comprises violation of an expected incident timeline.

A non-transitory processor readable medium is provided. The medium contains a set of instructions thereon that when executed by a processor cause the processor to receive an indication of an incident, the incident requiring a response from a first public safety agency and a second public safety agency. The instructions on the medium further cause the processor to retrieve, from a machine learning engine, an expected incident response from each of the first public safety agency and the second public safety agency, the expected response based on standard operating procedures of the first public safety agency and the second public safety agency. The instructions on the medium further cause the processor to identify a deviation from the expected incident response attributable to the second public safety agency. The instructions on the medium further cause the processor to retrieve, from the machine learning engine, a recommended course of action for the first public safety agency, the recommended course of action based at least in part on historical incident responses. The instructions on the medium further cause the processor to send the recommended course of action to the first public safety agency. The instructions on the medium further cause the processor to receive feedback related to the incident, the feedback including when the recommended course of action was accepted and an incident outcome. The instructions on the medium further cause the processor to update the machine learning engine based on the feedback.

In one aspect of the medium, the feedback includes an actual course of action when the recommended course of action was rejected. In one aspect the instructions on the medium further cause the processor to identify a skill set of a member of the second public safety agency associated with the deviation from the expected incident response, identify a skill set of a member of the first public safety agency that will receive the recommended course of action, wherein the recommended course of action is retrieved based on the skill set of the member of the second public safety agency and the skill set of the member of the first public safety agency.

In one aspect of the medium, the deviation comprises the second agency not being at an incident scene. In one aspect of the medium, the deviation comprises the second agency violating standard operating procedures. In one aspect of the medium, the deviation comprises violation of an expected incident timeline.

Further advantages and features consistent with this disclosure will be set forth in the following detailed description, with reference to the figures.

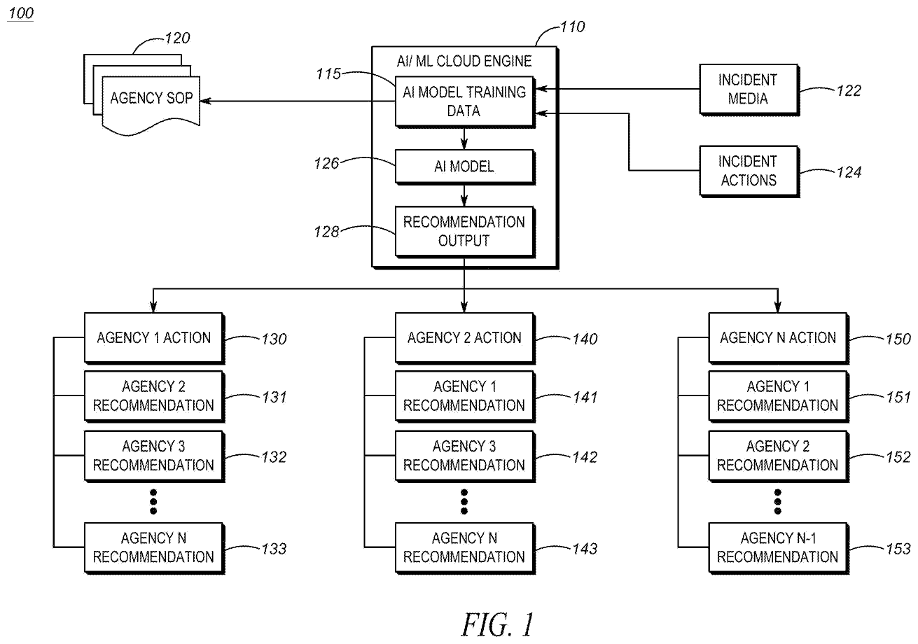

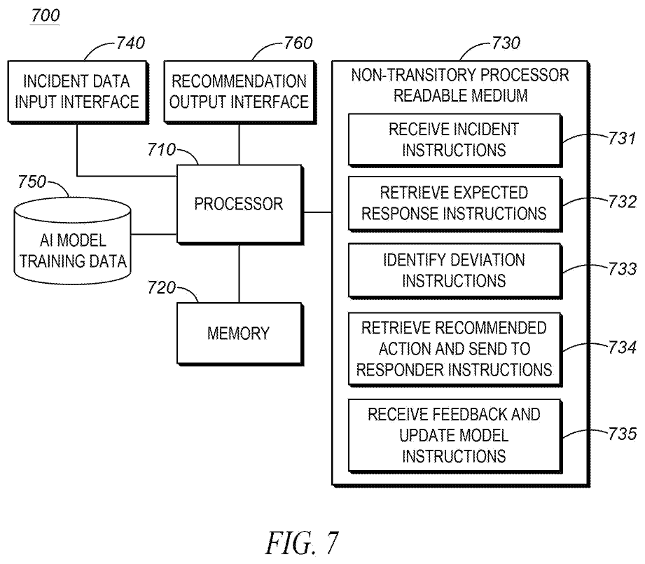

FIG. 1 is an example of a system 100 that may implement the inter-agency recommended course of action techniques described herein. The system includes an Artificial Intelligence (AI)/Machine Learning (ML) cloud engine 110. An example of a device that may be used to implement the AI/ML cloud engine is described with respect to FIG. 7, although it should be understood that the techniques described herein are not limited to any particular form of implementation. The AI/ML cloud engine is depicted as being implemented in a cloud computing environment, however other implementations, including on dedicated computing hardware are also suitable.

The AI/ML cloud engine 110 may include AI model training data 115. The AI model training data may take input from many different sources. For example, the training data may include agency Standard Operating Procedures (SOP) 120. As mentioned above, each agency may have defined SOP that determine what actions an agency should take during an incident. The SOP may also specify actions that should be taken when multiple agencies are cooperating with each other for an incident response.

The AI model training data 115 may also take input from incident media 122. Incident media may include audio and video of responses to incidents from the various different responding agencies. For example, first responders, in particular law enforcement officers, may be equipped with body worn cameras to record incident response details. Almost all first responders will be equipped with radio communications (e.g. Land Mobile Radio walkie-talkies, smartphones, etc.) which may be used for audio communications. In addition, there may be a plurality of other media, such as feeds from public and private fixed surveillance cameras.

Additional media may be provided from sensors, such as building sensors (e.g. smoke, fire, etc.) in a building where an incident occurs. The techniques described herein are not limited to any particular type of incident related media, and these are only examples. What should be understood is that incident media, which may reflect what is going on during an incident response, is made available to the AI model training data 115.

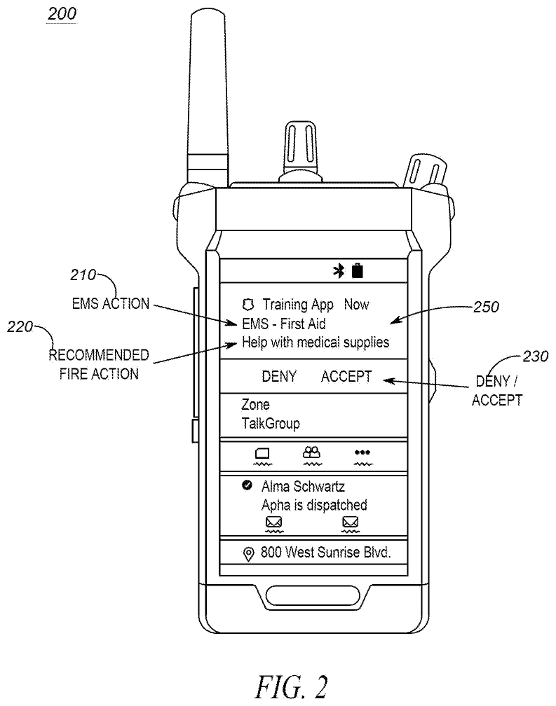

Yet another input to the AI model training data 115 are incident actions 124. The incident actions may indicate what actions each responder is taking in response to the incident. For example, a police officer arriving at a vehicle accident may, based on the SOP for the police agency, begin directing traffic. Incident actions 124 are provided to the AI model training data to indicate that the police officer has begun directing traffic. This information may be obtained directly from the responder (e.g. via a user device indicating a particular action is being taken—described in further detail with respect to FIG. 2) or may be derived through other means. For example, when beginning an action, the first responder may communicate such actions through incident media (e.g. radio communications, etc.). What should be understood is that AI model training data includes actions that are being taken by first responders.

The AI/ML cloud engine 110 may also include an AI model 126. AI model 126 may be trained using AI model training data 115. In the normal mode of operation, the AI model is trained with the agency specific and inter-agency SOPs. Upon receiving indication of an incident, the AI model may receive an action performed by a first responder from a first agency. Based on this action and the SOPs 120, the model may determine which actions to recommend to other agencies. Examples of such actions are described in further detail below, and with respect to Tables 1-4.

In addition to learning the expected actions based on the SOPs, the AI model 126 may also be able to detect when an action that should have been taken was not (e.g. deviation from SOP). In such case, the AI model may make a recommendation based on what was done in a historical situation when the same deviation occurred, wherein the outcome of that historical situation is taken into account when making the recommendation. The process of making recommendations when there is deviation from a response based on the SOPs is described in further detail below.

The AI/ML cloud engine 110 may also include recommendation output 128. The recommendation output may transmit recommendations to the agency responders via any available communications means. FIG. 2 describes a mechanism wherein the recommendation may be sent to a responders walkie-talkie via a text message. Other mechanisms may include sending the recommendation as a voice message (e.g. voice to text, etc.) or as a message through a terminal such as a mobile data terminal (MDT). What should be understood is that the recommendations are communicated to the first responders. In addition, an indication of whether the recommendation was accepted by the responder is returned to the AI Model Training Data 115 for use in further refining the model.

In operation, an incident that requires a response from multiple first responder agencies may occur. For purposes of this description, assume that the incident will require a response from the fire department, the EMS department, the police department, and the special weapons and tactics (SWAT) team. It should be understood that this is simply presented as an example. Any actual incident may need a response from other agencies or fewer agencies.

TABLE 1
Fire Department Actions

| Fire | Police | EMS | SWAT |
|---|---|---|---|
| Action | Recommendation | Recommendation | Recommendation |
| Victim | Offer Victim | Prepare to | Offer Victim |
| Rescue | Transport | administer CPR | Transport |
| Fire | Direct Vehicle | Help evacuate | N/A |
| Fighting | Traffic | People | |
| Open Path | Help Clear Area | N/A | Help Clear Area |
| Unblock | Help Clear Area | N/A | Help Clear Area |
| in/egress | | | |
| Toxic Gas | Help Evacuate | Prepare to | Search for |
| Protocol | People | administer CPR | explosive material |

As shown in Table 1, the leftmost column is the action taken by the fire department. Based on the action taken by the fire department, recommendations may be made to other agencies for the course of action they should take. For example, assume that the action that the fire department is taking is to perform a victim rescue (e.g. vehicle extraction, etc.). This action may be represented in FIG. 1 as agency 1 action 130. Upon detection by the AI/ML cloud engine 110 that fire department is engaging in a victim rescue, the recommendation output 128 from the AI model 126 may be to recommend that the police offer to transport victims 131, EMS should prepare to perform CPR 132, and that the SWAT team should also offer to transport victims 133.

TABLE 2
EMS Actions

| EMS | Police | Fire | SWAT |
|---|---|---|---|
| Action | Recommendation | Recommendation | Recommendation |
| Treat | N/A | Help with medical | N/A |
| Injuries with | | supplies | |
| Bandages | | | |
| Transport | Direct Traffic | Transport victim | Help Coordinate |
| to hospital | away from | | with hospitals |
| | transport route | | |
| First Aid | N/A | Help with | N/A |
| | | medical supplies | |
| CPR | Help with triage | Assist with CPR | N/A |

As shown in Table 2, the leftmost column indicates actions taken by EMS responders. The remaining columns indicate actions that could be recommended to other responders. For example, if the action taken by EMS is to perform first aid, this action may be represented as agency 2 action 140. The recommendation output 128 from the AI model 130 may be to recommend that the police take no action 141, that the fire department assists with CPR 142, and that the SWAT team also takes no action 143. The reason why in some cases no action is recommended will be described in further detail below.

TABLE 3
Police Actions

| Police | Fire | EMS | SWAT |
|---|---|---|---|
| Action | Recommendation | Recommendation | Recommendation |
| Establish | N/A | Prepare for | Coordinate |
| Perimeter | | medical injuries | building entry |
| Suspect | Help clear area | N/A | Prepare barricades |
| Pursuit | | | |
| Neutralize | N/A | N/A | Deploy Snipers |
| Shooter | | | |
| Surveillance | N/A | N/A | Coordinate |
| | | | building entry |

TABLE 4
SWAT Actions

| SWAT | Police | EMS | Fire |
|---|---|---|---|
| Action | Recommendation | Recommendation | Recommendation |
| Establish | Assist | Prepare for | N/A |
| Perimeter | Establishing | medical injuries | |
| | Perimeter | | |
| Sharp | Establish | Prepare to treat | Prepare to |
| shooting/ | Perimeter | gunshot wounds | transport victims |
| snipers | | | |
| Disarm | Help clear area/ | Prepare to treat | Help search for |
| Bomb | crowd control | explosion injuries | explosive materials |

Tables 3 and 4 are included to describe similar actions/recommendations when a police action or SWAT action occurs. Just as with Tables 1 and 2, the actions taken by an agency may be depicted in FIG. 1 as agency action N 150. The recommendations for each other agency may be depicted by agency 1−N−1 recommendations 151-153. Again, it should be noted that the tables described above are only an example. An actual incident may require responses from more or fewer agencies.

The actions taken by an agency may be specified in the SOPs 120 input into the AI model training data 110. The AI model 130 itself may be trained by analyzing the SOPs and determining recommended actions for the other agencies based on those SOPs. In other words, the AI model does not necessarily need to be pre-programmed with the recommendations and they are learned from the SOPs themselves. As will be described in further detail below, in some cases, the AI Model will further learn from when a first responder deviates from the expected course of action by either rejecting a recommendation or not performing an action that should have been performed based on the SOP.

It should further be noted that for some actions by one agency, the recommended action to other agencies may be N/A, indicating that there is no recommended action. For example, in Table 3, in the case of a police action to neutralize a shooter, the recommended action for fire and EMS is no action. The AI model will not recommend an agency perform a course of action if that course of action is beyond the skill set of that agency. In this particular example, if the training of the Fire and EMS personnel does not include training to assist in active shooter situations, it would be potentially dangerous to recommend a course of action to those responders other than take no action.

It should further be noted that action inputs by different agencies are handled in the order in which they are received. So, if a police action is received, recommendations based on that action may be sent to the other agencies. If an EMS action is subsequently received, the recommendations to the other agencies may be sent. In the case where two actions are received at substantially the same time, priority may be given to the agency that is considered primary based on the incident type. For example, in a fire type of incident, the fire department would be given priority, whereas in an active shooter incident police/SWAT would be given priority.

In addition, although presented as a single action from an agency results in a single set of recommended actions to other agencies, this was for purposes of ease of description only. In an actual incident response, responders from the same agency may be assigned different tasks, and as such take different actions. Likewise, the other agencies may also have different responders associated with each of those tasks. For example, consider an incident involving a hostage situation, a bomb threat, and a burning building. There may be police and SWAT responders assigned to deal with the hostage situation. Actions by each of those agencies will only generate recommendations for other responders assigned to the hostage situation. In the example above, there would be no recommendations to fire and EMS, because no one from those agencies was assigned to respond to the hostage situation.

For the bomb threat aspect, there may be police, SWAT, and fire responders assigned. Actions by each of those agencies will only generate recommendations for the other two, but only to responders assigned to the bomb threat aspect. For example, if a police responder takes an action, recommendations would not be provided to the SWAT officer assigned to the hostage task, but would be provided to the SWAT and Fire responders assigned to the bomb threat task. Likewise, if police, fire, EMS, and SWAT were assigned to the burning building aspect of the incident, recommendations would only be provided to the members of other agencies that were also assigned to deal with the burning building aspect of the incident.

Although grouping of responders based on assigned tasks has been described, the techniques described herein are not so limited. In some cases, the groupings may be defined in terms of locations, such that all responders within a given location area (e.g. geofence, incident area, etc.) may be assigned to the same group and receive recommendations accordingly. Such grouping may be helpful when there are two separate incidents occurring in two different areas.

Although recommendations may be provided in a relatively static manner as defined by SOPs, the recommendations may also include more dynamic information and/or special factors which can be used to customize the recommendations. For example, there may be special factors in play that could not be accounted for in the SOPs. For example, a building may currently be known to be vacant (e.g. under construction, alarm system set to indicate owner is away, etc.). In such a case, it is expected that there will not be any human victims requiring treatment by EMS. As such, no recommendations may be provided to EMS responders. In another example, special circumstances may indicate there is an above normal amount of injured persons (e.g. excessive reported injuries, etc.). In such a case, more weight may be given to EMS recommendations, as there would be more EMS work than would normally be required for a vacant building.

FIG. 2 is an example of a device 200 which may be used to send recommendations to an agency responder and receive a response indicating if the recommendation was accepted. The example device presented in FIG. 2 may be a portable radio, often referred to as a walkie-talkie. Modern portable radios may include processing power and user interface capabilities that are similar to modern smartphones. For example, they may be equipped with screens 250 that allow the display of text messages as well as providing a touch interface for allowing user input.

The device 200 may receive a message indicating an action that is being performed by a different agency. In this example, the device may be associated with a fire department responder. The message 210 may indicate that EMS is performing an action. In this example, the action described is that EMS is performing first aid. In the example of recommended actions described in Table 2, when EMS is engaged in the action of First Aid, the recommended action for the fire department is to help with medical supplies. As such, the recommended fire action 220 sent to the fire department device is to help with medical supplies.

The first responder is then given the option to indicate if they will comply with the recommendation (e.g. accept the recommendation) or not (reject the recommendation). The responder is provided with a user interface 230 that allows the responder to communicate to the AI/ML cloud engine if they are going to perform the recommended action (e.g. accept) or not perform the recommended action (e.g. deny). As will be explained in further detail below, this information may be collected by the AI model training data 115 and used to further train the AI model 130 for making recommendations in the future.

Although a device in the form of a portable radio is described, it should be understood that this was for ease of description only. The actual responder device could be of any form factor (e.g. smartphone, laptop computer, vehicle based radio terminal, mobile data terminal, etc.). Furthermore, although the example interface shown is a visual interface, this is for purposes of ease of description. Another possible interface is an audio interface in which the recommendations are converted to speech and provided to the responder.

In addition, the response may be more complex than a simple accept/deny response. In some implementations, the AI/ML cloud engine 110 may solicit further feedback from the responder when the responder makes a decision to reject the recommendation. For example, the responder may be asked to provide a reason why they rejected the recommendation. Just as with providing the recommendation, the response could either be textual (e.g. responder types in the reason the recommendation was rejected) or audible (responder speaks the reason why the recommendation was rejected, and the speech is converted for input to the AI/ML cloud engine). Regardless of how the feedback is received the AI/ML cloud engine may use this information when making future recommendations. In addition, the rejection of a recommendation may be considered a deviation from procedures. Handling deviations will be described in further detail below.

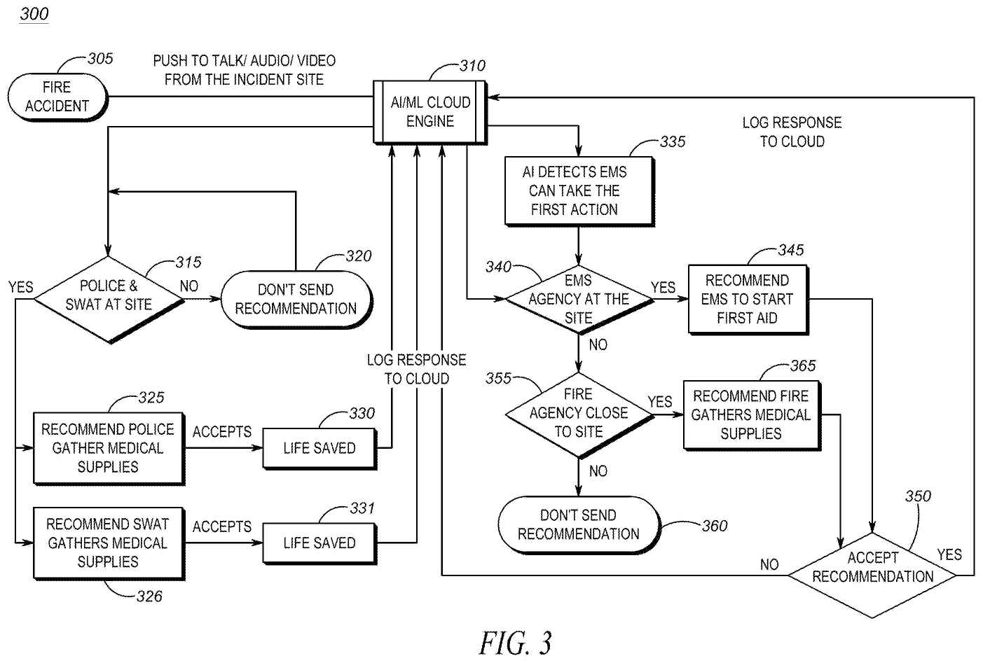

FIG. 3 is an example of a flow diagram 300 of providing inter-agency recommended courses of action for a specific incident according to the techniques described herein. In block 310 an indication of an incident, in this example a fire accident, may be sent to the AI/ML cloud engine 310. Because this is a fire related incident 305, the lead agency for the incident may be the fire department. The AI/ML cloud engine may then provide recommendations for a course of action to be taken by other agencies. In this example, assume the other agencies are police, SWAT, and EMS.

In block 315, the system may determine if the police and SWAT agencies are at the site of the incident. It should be clear that it does not make sense to provide recommended courses of action to responders that are not yet at the incident scene. If the police and SWAT agencies are not yet on site, in block 320, no recommendations are sent. In some implementations, the process may return to block 315 to continue to check if the police and SWAT agencies have arrived on site.

If the police and SWAT agencies are on site, in blocks 325 and 326, recommendations may be provided to those agencies. As described above the recommendations may have come from analysis of the SOPs and/or historical actions that were taken in the past that resulted in successful outcomes. In this particular example, each of the agencies is provided a recommendation that they should gather medical supplies. As these agencies may not be directly involved in fighting the fire, gathering medical supplies to assist in treating victims may be the most useful course of action. Both the police and SWAT agencies may accept the recommended action and begin gathering medical supplies.

In blocks 330 and 331, the outcome of the recommendation may be fed back into the AI/ML cloud engine 310 to further train the AI model. Because the outcome in this case is that life was saved, the AI/ML cloud engine is able to learn that the course of action recommended was successful in producing a positive outcome. If the outcome was negative, the AI/ML cloud engine may not recommend that course of action in future incidents.

In some cases, even though an incident may be of a certain type (e.g. a fire incident), the agency associated with that incident type may not necessarily be the first agency that can take action. For example, in block 335, the AI may detect that EMS is able to take the first action. For example, when the incident was reported (e.g. 911 call, etc.) there may have been information provided indicating there are injured persons. As such, even though this is a fire based incident, EMS may be able to take the first action.

In block 340, it may be determined if the EMS agency is at the incident site. If so, in block 345, a recommendation to start first aid may be sent to the EMS responder. In block 350, the responder can indicate if the recommendation is accepted or not. In either case, the acceptance/rejection is fed back to the AI/ML cloud engine 310 for use in making recommendations in the future.

If the EMS agency is not on site, in block 355 it can be determined if another agency, such as the fire agency is close to the site. If not, as shown in block 360, no recommendations may be sent to the fire agency. If they are nearby, in block 365 a recommendation may be sent to the fire agency to begin gathering medical supplies. Just as in all the other cases, the fire agency can choose to accept or reject the recommendation. In either case, the acceptance/rejection of the recommendation and the outcome of the incident is fed back to the AI/ML cloud engine 310 for use in providing future recommendations.

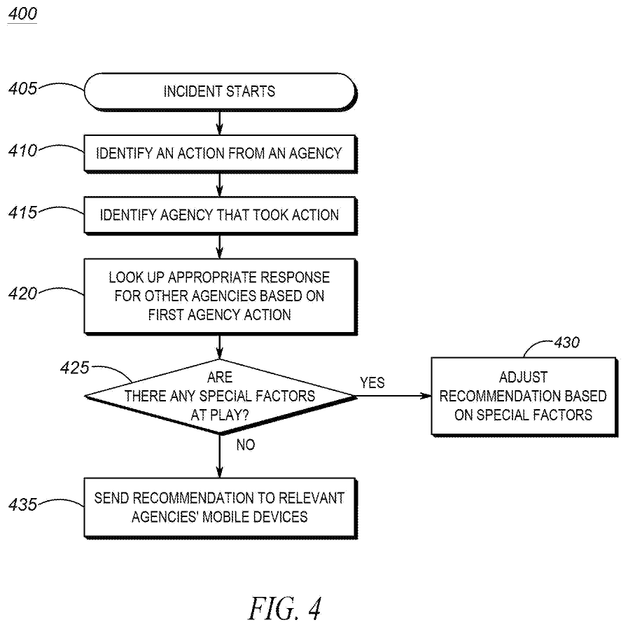

FIG. 4 is a general example of a flow diagram 400 providing inter-agency recommended courses of action for a specific incident according to the techniques described herein. In block 405, an incident starts. As described above, the incident may require a response by multiple agencies (e.g. police, EMS, fire, etc.). In many cases, the incident may have a lead agency. For example, the fire department may be the lead agency for a fire incident. Although an incident may have a lead agency, the first agency to perform an action to respond to the incident may not necessarily be the lead agency. For example, if the police department arrives at a fire incident scene prior to the fire department, the police may initiate the first action, even though they are not the lead agency.

In block 410, an action performed by a responding agency may be identified. The action could be identified via media sent to the system (e.g. radio communications, video imagery, etc.) or could be determined based on sensors covering the incident response area. Regardless of the mechanism, the system receives an indication that an agency performed an action, and that action is identified.

In block 415, the agency that took the action is identified. As described above, in some cases, an action can be performed by more than one agency. Recommendations for a course of action for other agencies may be dependent on what actions have already been performed. For example, if a task was completed by an agency, it does not make sense to recommend completing that task to the same agency or other agencies.

In block 420, an appropriate response for the other agencies can be looked up based on the first agency action. It should be understood that looking up a recommended action is not a simple table look up. Rather an AI model that has been trained based on agency and inter-agency SOPs, as well as on actual actions taken in previous incident responses, including the outcomes of those previous responses, looks at the current agency action, and determines a recommendation for other agencies based on the model training.

In block 425, it is determined if there are any special factors in play. In the description above, it is generally assumed that all agencies are acting in accordance with the SOPs and recommendations provided by the AI model. However, it is possible that the responders either reject the recommendations, or they perform some action that has not been recommended. Such cases mean there are special factors in play, and simply following the AI model recommendation may not be appropriate. Such special factors, in some cases, can include deviations. Further description of deviations will be described below. In block 430, the recommendation may be adjusted based on the determined factors.

In block 435, the recommendations may be sent to the relevant agencies mobile devices (e.g. device 200). As explained previously, the agency receiving the recommendation may choose to accept or reject the recommendation. The acceptance or rejection of the recommendation, as well as the outcome of the incident, may be provided to the AI model for further training and improvement of recommendations in future incidents.

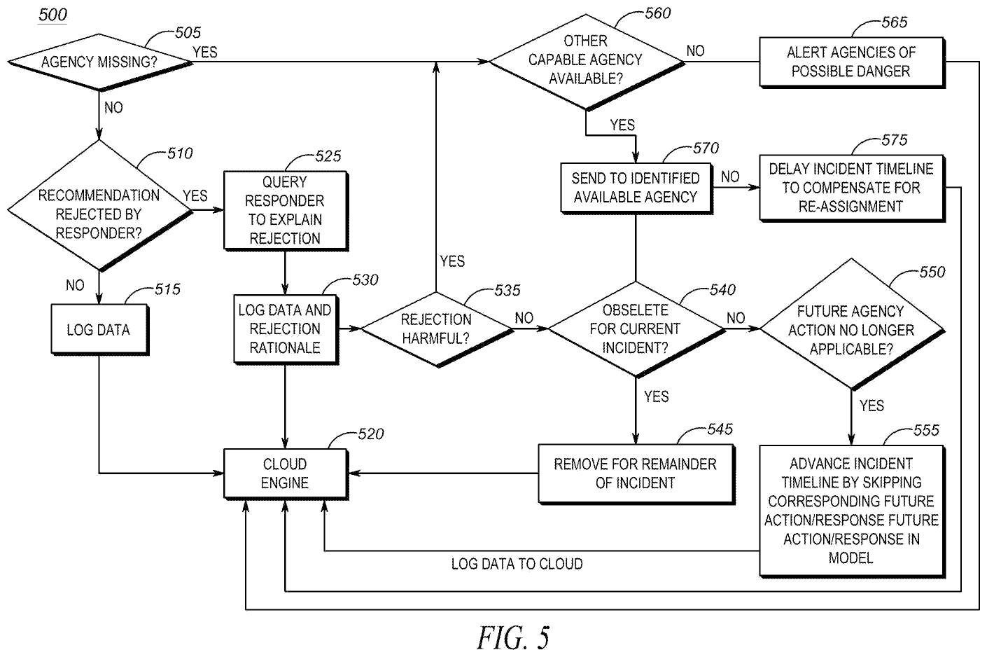

FIG. 5 is an example of a flow diagram 500 of providing inter-agency recommended courses of action when an agency deviates from the standard operating procedures. FIG. 5 may be viewed as a continuation of FIG. 4 that begins once an action recommendation has been determined and it is being sent to a responding agency. In block 505, it may be determined if there is an agency that is missing from the incident response. For example, the agency may not have arrived yet. As another example, the agency may have prematurely left the incident response area. In some cases, the agency leaving the response area early may be viewed as a deviation from the SOPs. As will be described in further detail below, in some cases, deviation from the SOPs by an agency may require corrective action be taken by other responding agencies.

If all required agencies are at the incident scene, in block 510 it is determined if the recommendation has been rejected by the agency. If the agency accepts the recommendation, it is logged 515 by the system for use in future incident responses by the cloud engine 520. Although not shown, the process then returns to waiting for the next agency action and determining recommendations for other agencies.

If the recommendation is rejected, the process moves to block 525, where the responder may be queried to explain the rejection. The query may be in the form of an audible query, such as is common with the use of digital virtual assistants or it could be a textual response from the responder indicating the reason why the recommendation was rejected. Regardless of how obtained, the reason for rejecting the recommendation is logged 530 by the system for use in generating future recommendations. For example, if the rejection of a recommendation resulted in a poor outcome of the incident, the system may use that information in the future when determining what to do if a recommendation is rejected.

For example, in block 535, it may be determined if the rejection of the recommendation would be harmful. For example, if in previous incident responses, failure to complete the recommended action resulted in a poor outcome (e.g. victim died, criminal suspect escapes, etc.) the system may determine that the rejection constitutes a deviation that requires correction. In such cases, the process moves to block 560, which will be described in further detail below.

If it is determined that the rejection of the recommendation is not harmful, the process moves to block 540. In block 540, it may be determined if the recommended action is obsolete for the current incident. For example, consider a vehicle accident where the victim has already been extracted from the damaged vehicle and is on the way to the hospital. A recommendation to gather medical supplies for this incident would be obsolete, as there is no longer a victim on site who would use those medical supplies. Even though the incident may not be over, the recommendation to gather medical supplies would no longer be provided for this particular incident 545. One thing that should be noted is that although the recommendation will no longer be made for this incident, the AI model is not retrained to remove the recommendation, as it may still be applicable in future incidents.

In block 550, it may be determined if future agency action is no longer applicable. In many incident responses, actions are taken in accordance with an incident timeline. For example, in the case of a medical response to a vehicle accident where criminal activity (e.g. riot, etc.) is ongoing, an incident timeline may be police set up a perimeter, police secure riot participants, SWAT provides overwatch of the incident scene until secure, fire extracts the victim, and EMS provides treatment and transport to the victim. If upon arrival at the incident scene, it is determined that all criminal activity has dissipated, there is no need for those timeline actions to be performed.

In such a case, in block 555, the incident timeline could be advanced to skip those actions that are no longer necessary. In the example presented, because there is no longer any criminal activity present, actions by the police and SWAT may be skipped. The incident timeline can be advanced to the next action that will be needed given the current incident state. In this example, the next action to be recommended would be for the fire department to extract the victim. This information may be logged, but again, it should be understood that no changes to the AI model are made, as the omission of certain steps was specific to this incident. In the next incident, the entire incident timeline may need to be executed.

In block 560 the system has determined that either the agency it wishes to send a recommendation to is either not yet at the scene or the agency has received the recommendation but has chosen to reject the recommendation (i.e. a deviation). In such cases, the system may have determined that failure to perform the recommended action would result in a poor overall outcome for the incident response. As such, the system may determine that it should find another agency to send a recommendation to perform the action. In block 560, the system determines if another capable agency is available.

The determination of a capable agency is to ensure that a recommendation to perform an action is not sent to an agency that is not capable of performing the action. For example, in the case of a vehicle extraction that requires extraction tools, a recommendation to execute that action may not be made to an EMS responder, as they lack the necessary equipment to perform the recommended action. If no capable agency is available, the process moves to block 565. In block 565, the other agencies may be sent an alert of possible danger (e.g. through mobile device 200) because an action that has been determined to be important has not been completed. The outcome of the incident may be logged, such that the AI model can be trained to determine if omission of the action actually resulted in a poor outcome. If not, the AI model may be retrained to indicate that the particular omitted action is not always critical for a response to that incident type.

If a capable agency is identified, the process moves to block 570. In block 570, the recommended action may be sent to the available agency. Because the recommended action is being sent to an agency that would not normally have been responsible for that action, there may need to be adjustments made to the incident timeline. In block 575, the incident timeline may be delayed to compensate for the reassignment of the action. For example, if in a vehicle accident response the timeline is police department redirects traffic and only then can the fire department extract the victim, and the police department either is not yet on scene or refuses to redirect traffic, then the recommendation may be sent to the fire department. However, because the fire department is now occupied with another action, the timeline may be delayed, because victim extraction cannot immediately begin.

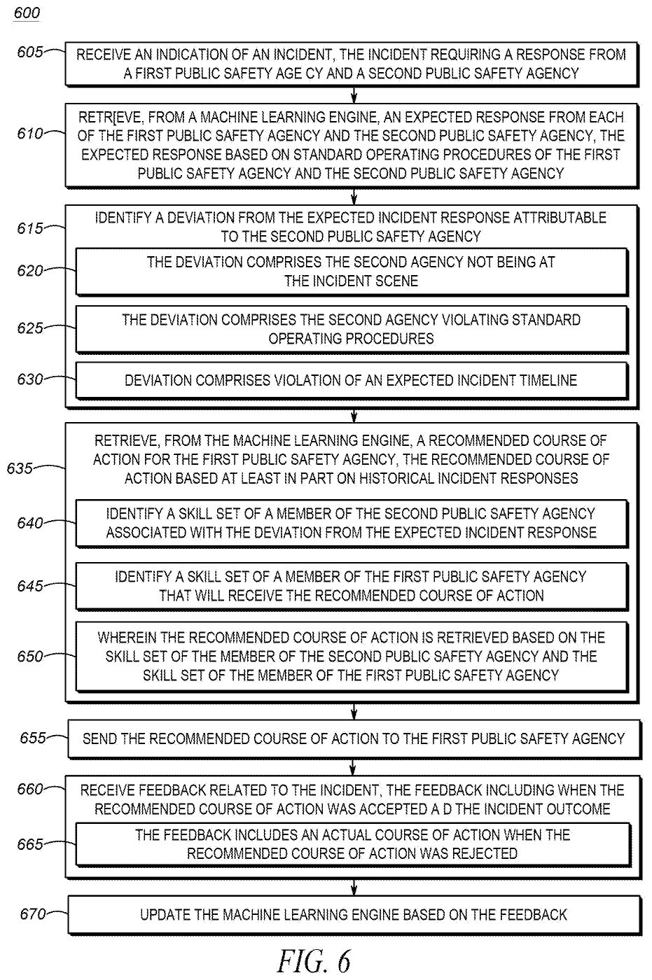

FIG. 6 is another example of a flow diagram 600 of providing inter-agency recommended courses of action when an agency deviates from the standard operating procedures. As mentioned above, in many cases agencies have well defined procedures for multiple agency incident responses. Each agency has defined actions that they are supposed to take. In addition, there may be an incident response timeline which determines the order and timing of execution of each of those actions.

However, a problem can arise when the actions are not executed according to the SOPs. When the SOPs are not followed, this may be referred to as a deviation. A deviation may be unintentional (e.g. an agency that is needed for an incident has not yet arrived on scene). In other cases the deviation may be intentional. For example, an agency may knowingly not follow SOPs for one reason or another.

In block 605, an indication of an incident may be received. The incident may require a response from a first public safety agency and a second public safety agency. Although the description is in terms of a response from two agencies, this is for ease of explanation only. The techniques described herein are suitable for use in any incident response that requires responses from more than one agency.

In block 610, an expected response from each of the first public safety agency and the second public safety agency may be retrieved from a machine learning engine. The expected response may be based on standard operating procedures of the first public safety agency and the second public safety agency. As explained above, the various agencies may have previously created training plans that describe how the agencies will interact with each other. These previously created training plans may be used to train a machine learning engine to provide recommendations to the public safety agencies with respect to what actions should be taken when responding to an incident.

In block 615, a deviation from the expected incident response attributable to the second public safety agency may be identified. In other words, the second public safety agency may perform an action that was not expected or may fail to perform an action that was expected. The reason for the deviation is relatively unimportant. The deviation could be intentional or unintentional, malicious or benign, consistently deviating or a one-off case. In general, what should be understood is that the actions performed by the second agency are not consistent with the action that was expected.

In one example 620, the deviation comprises the second agency not being at the incident scene. This can mean that the agency has not yet arrived at the incident scene. For example, the agency may be caught in traffic responding to the incident scene. As yet another example, the agency may have simply missed the call to respond to an incident. In another example, the second agency not being at the incident scene may have occurred because the second agency left the incident prematurely. For example, the agency may have mistakenly thought all of its tasks for the incident were complete and therefore could leave the incident scene.

In another example 625, the deviation comprises the second agency violating standard operating procedures. For example, the agency may be required to perform some action based on the SOPs. An agency may fail to comply for any number of reasons. For example, poor training may cause an agency to violate SOPs. Responders being mentally exhausted may be another reason for failure to comply with SOPs.

In yet another example 630, the deviation comprises violation of an expected incident timeline. As mentioned above, many incidents have a response timeline defined where certain agencies are expected to take certain actions in a certain defined order when responding to an incident. If an agency fails to perform one or more of those actions in accordance with the incident timeline, this would be a violation of the expected timeline. The particular reason for the timeline violation is unimportant. What should be understood is that the expected actions from the incident response timeline did not occur in the order and at the time expected.

Although three different types of deviations have been described, it should be understood that the techniques described herein are not limited to those three examples. What should be understood is that the system is expecting certain actions to be performed by the second public safety agency, in some cases at a specific time. If those actions do not occur, it is a deviation that will be addressed by providing recommendations for other agencies to take an action to mitigate the failure of the second public agency from executing the expected action.

In block 635 a recommended course of action for the first public safety agency may be retrieved from the machine learning engine. The recommended course of action may be based at least in part on historical incident responses. As explained above, the SOPs may determine what actions are to be taken. However, if the SOPs are not followed, the recommendation may be based on what actions were actually taken in other incident responses where the SOPs were not followed. In other words, if in a previous incident response, the second public safety agency did not perform and expected action, what did the first public safety agency actually do to mitigate the failure? As will be explained in further detail below, the outcome of that action by the first public safety agency may be used to determine if a recommendation to perform that same action is made in the future.

In block 640, a skill set of a member of the second public safety agency associated with the deviation from the expected incident response may be identified. The skill set identifies what actions the member of the second public safety agency is capable of performing. Likewise, in block 645, a skill set of a member of the first public safety agency that will receive the recommended course of action is identified. Again, the skill set identifies what actions the member of the first public safety agency is capable of performing.

In block 650, the recommended course of action is retrieved based on the skill set of the member of the second public safety agency and the skill set of the member of the first public safety agency. In other words, the recommended action is retrieved based on the member of the first public safety agency actually having the capability to perform an action that should have been done by the member of the second public safety agency. For example, if the action to be performed by the second public safety agency was to begin performing CPR and the second agency did not engage in that action, it does not make sense to recommend that a member of the first public safety agency perform CPR if no member of the first public safety agency has CPR within their skill set.

In block 655, the recommended course of action may be sent to the first public safety agency. As explained above, the recommended course of action may be sent to the first public safety agency by way of a mobile device, such as the one depicted in FIG. 2. It should be understood that communication through such a device is by way of example, and the techniques described herein are not so limited. The recommendation for a course of action can be sent through any available communications mechanism.

In block 660, feedback related to the incident may be received. The feedback may include when the recommended course of action was accepted and the incident outcome. As described above, the agency receiving the recommended course of action may either accept or reject the recommendation. When the recommendation is rejected, there may be a request for a reason why the recommendation was rejected. Furthermore, the actual outcome of the incident (e.g. positive, negative, etc.) may be received. The AI model may be trained based on this feedback in order to improve future recommendations. For example, if a particular recommendation is consistently associated with negative outcomes, the AI model may learn from this feedback and no longer provide that particular recommendation.

In block 665, the feedback includes an actual course of action when the recommended course of action was rejected. If the first public safety agency rejects the recommended course of action, there are two possibilities. Either no action at all is taken or some action, other than what was recommended, is taken. In either case, this information may be included as part of the feedback. If the action taken (or even the lack of any action taken) produces a favorable outcome to the incident response, that can be used for future responses.

In block 670, the machine learning engine may be updated based on the feedback. By updating, or retraining, the machine learning engine taking into account the actual actions that were performed, as well as the outcome of those incidents, the AI model may be continuously improved to provide recommendations that have historically resulted in favorable outcomes and not recommending actions that have not resulted in favorable outcomes. Thus, the system is able to make recommendations for actions that are based on what has actually been done in the past, as opposed to being constrained by those actions defined in the SOPs.

FIG. 7 is an example of a device 700 that may implement the providing inter-agency recommended courses of action techniques described herein. It should be understood that FIG. 7 represents one example implementation of a computing device that utilizes the techniques described herein. Although only a single processor is shown, it would be readily understood that a person of skill in the art would recognize that distributed implementations are also possible. For example, the various pieces of functionality described above (e.g. identifying deviations, recommending courses of action, etc.) could be implemented on multiple devices that are communicatively coupled. FIG. 7 is not intended to imply that all the functionality described above must be implemented on a single device.

Device 700 may include processor 710, memory 720, non-transitory processor readable medium 730, incident data input interface 740, AI model training data 750, and recommendation output interface 760.

Processor 710 may be coupled to memory 720. Memory 720 may store a set of instructions that when executed by processor 710 cause processor 710 to implement the techniques described herein. Processor 710 may cause memory 720 to load a set of processor executable instructions from non-transitory processor readable medium 730. Non-transitory processor readable medium 730 may contain a set of instructions thereon that when executed by processor 710 cause the processor to implement the various techniques described herein.

For example, medium 730 may include receive incident instructions 731. The receive incident instructions 731 may cause the processor to receive details of an incident that requires a response. For example, the incident detail could be received via the incident data input interface. The interface may receive information that also includes SOPs 120, incident media 122, and incident actions 124. The instructions may also cause the received data to be stored in the AI Model training database 750 in order to be used to retrain the AI model based on historical actions taken and the success of those actions. The receive incident instructions 731 are described throughout this description generally, including places such as the description of block 605.

The medium 730 may include retrieve expected response instructions 732. The retrieve expected response instructions 732 may cause the processor to retrieve, from the AI model, an expected response from one agency based on the actions of another agency. The retrieve expected response instructions 732 are described throughout this description generally, including places such as the description of block 610.

The medium 730 may include identify deviation instructions 733. The identify deviation instructions 733 may cause the processor to determine when an agency's actions have deviated, for whatever reason, from the actions the agency was expected to take. The identify deviation instructions 733 are described throughout this description generally, including places such as the description of blocks 615-630.

The medium 730 may include retrieve recommended action and send to responder instructions 734. The retrieve recommended action and send to responder instructions 734 may cause the processor to retrieve the recommended action from the AI model and send the recommendation to the first responder. For example, the processor may send the recommended action to the first responder using the recommendation output interface 760. The recommendation output interface 760 may allow for communication with responder devices, such as the device described with respect to FIG. 2. The retrieve recommended action and send to responder instructions 734 are described throughout this description generally, including places such as the description of blocks 635-650.

The medium 730 may include receive feedback and update AI model instructions 735. The receive feedback and update AI model instructions 735 may cause the processor to receive feedback from the first responder, through the incident data input interface 740, to determine if recommended action was taken by the responder (and what action was taken if it was not) and determine the outcome of the incident. This information may be used to update the AI model such that recommendations made in future incidents may take into account recommended actions from past incidents. The receive feedback and update AI model instructions 735 are described throughout this description generally, including places such as the description of blocks 655-670.

As should be apparent from this detailed description, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot implement an artificial intelligence/machine learning model that takes into account all available SOPs, detects deviations from different agencies, and sends recommendations to other agencies, among other features and functions set forth herein).

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through an intermediate element or device via an electrical element, electrical signal or a mechanical element depending on the particular context.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method comprising:
receiving an indication of an incident, the incident requiring a response from a first public safety agency and a second public safety agency;
retrieving, from a machine learning engine, an expected incident response from each of the first public safety agency and the second public safety agency, the expected response based on standard operating procedures of the first public safety agency and the second public safety agency;
identifying a deviation from the expected incident response attributable to the second public safety agency;
retrieving, from the machine learning engine, a recommended course of action for the first public safety agency, the recommended course of action based at least in part on historical incident responses;
sending the recommended course of action to the first public safety agency;
receiving feedback related to the incident, the feedback including when the recommended course of action was accepted and an incident outcome; and
updating the machine learning engine based on the feedback.

2. The method of claim 1 wherein the feedback includes an actual course of action when the recommended course of action was rejected.

3. The method of claim 1 further comprising:
identifying a skill set of a member of the second public safety agency associated with the deviation from the expected incident response;
identifying a skill set of a member of the first public safety agency that will receive the recommended course of action;
wherein the recommended course of action is retrieved based on the skill set of the member of the second public safety agency and the skill set of the member of the first public safety agency.

4. The method of claim 1 wherein the deviation comprises the second agency not being at an incident scene.

5. The method of claim 1 wherein the deviation comprises the second agency violating standard operating procedures.

6. The method of claim 1 wherein the deviation comprises violation of an expected incident timeline.

7. A system comprising:
a processor; and
a memory coupled to the processor, the memory containing a set of instructions thereon that when executed by the processor cause the processor to:
receive an indication of an incident, the incident requiring a response from a first public safety agency and a second public safety agency;
retrieve, from a machine learning engine, an expected incident response from each of the first public safety agency and the second public safety agency, the expected response based on standard operating procedures of the first public safety agency and the second public safety agency;
identify a deviation from the expected incident response attributable to the second public safety agency;
retrieve, from the machine learning engine, a recommended course of action for the first public safety agency, the recommended course of action based at least in part on historical incident responses;
send the recommended course of action to the first public safety agency;
receive feedback related to the incident, the feedback including when the recommended course of action was accepted and an incident outcome; and
update the machine learning engine based on the feedback.

8. The system of claim 7 wherein the feedback includes an actual course of action when the recommended course of action was rejected.

9. The system of claim 7 further comprising instructions to:
identify a skill set of a member of the second public safety agency associated with the deviation from the expected incident response;
identify a skill set of a member of the first public safety agency that will receive the recommended course of action;
wherein the recommended course of action is retrieved based on the skill set of the member of the second public safety agency and the skill set of the member of the first public safety agency.

10. The system of claim 7 wherein the deviation comprises the second agency not being at an incident scene.

11. The system of claim 7 wherein the deviation comprises the second agency violating standard operating procedures.

12. The system of claim 7 wherein the deviation comprises violation of an expected incident timeline.

13. A non-transitory processor readable medium containing a set of instructions thereon that when executed by a processor cause the processor to:
receive an indication of an incident, the incident requiring a response from a first public safety agency and a second public safety agency;
retrieve, from a machine learning engine, an expected incident response from each of the first public safety agency and the second public safety agency, the expected response based on standard operating procedures of the first public safety agency and the second public safety agency;
identify a deviation from the expected incident response attributable to the second public safety agency;
retrieve, from the machine learning engine, a recommended course of action for the first public safety agency, the recommended course of action based at least in part on historical incident responses;
send the recommended course of action to the first public safety agency;
receive feedback related to the incident, the feedback including when the recommended course of action was accepted and an incident outcome; and
update the machine learning engine based on the feedback.

14. The medium of claim 13 wherein the feedback includes an actual course of action when the recommended course of action was rejected.

15. The medium of claim 13 further comprising instructions to:
identify a skill set of a member of the second public safety agency associated with the deviation from the expected incident response;
identify a skill set of a member of the first public safety agency that will receive the recommended course of action;
wherein the recommended course of action is retrieved based on the skill set of the member of the second public safety agency and the skill set of the member of the first public safety agency.

16. The medium of claim 13 wherein the deviation comprises the second agency not being at an incident scene.

17. The medium of claim 13 wherein the deviation comprises the second agency violating standard operating procedures.

18. The medium of claim 13 wherein the deviation comprises violation of an expected incident timeline.
